(19) United States
(12) Patent Application Publication
(10) Pub. No.: US 2025/0054054 A1
(43) Pub. Date: Feb. 13, 2025

(54) REAL ESTATE LISTINGS MAP GUI GENERATION SYSTEM

(71) Applicant: Opendoor Labs Inc., San Francisco, CA (US)

(72) Inventors: Robert Bernal, Berkeley, CA (US); Ravi Kirit Sathia, Hoffman Estates, IL (US)

(21) Appl. No.: 18/231,454

(22) Filed: Aug. 8, 2023

(51) Int. Cl. G06Q 30/0601; G06F 3/0481; G06F 3/04842; G06Q 10/087; G06Q 50/16

(52) U.S. Cl. CPC G06Q 30/0643; G06F 3/0481; G06F 3/04842; G06Q 10/087; G06Q 50/16; G06F 2203/04806

(57) ABSTRACT

Described is a system for generating a map corresponding to a particular region, accessing MLS real estate inventory data, accessing non-MLS real estate inventory data, displaying the generated map comprising a first set of visual indicators, each visual indicator of the first set of visual indicators displayed at a location corresponding to an MLS real estate listing, and displaying a second set of visual indicators on the generated map, each visual indicator of the second set of visual indicators displayed at a location corresponding to a non-MLS real estate property. In response to detecting the selection of a visual indicator in the first set of visual indicators, changing the first set of visual indicators for the MLS real estate listings to the second set of visual indicators, and changing the second set of visual indicators for the non-MLS real estate listings to the first set of visual indicators.

### BACKGROUND

Users of electronic devices are increasingly utilizing an electronic display of a map for an area to identify real estate listings of interest. For example, a user can specify criteria, such as price range, property type and number of bedrooms or bathrooms, and the map will highlight available properties that meet those parameters.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a block diagram illustrating a networked system for predicting a value for a real-estate property, according to some example embodiments.

FIG. 2 illustrates an example method 200 for generating and updating real estate visual indicators on a map in a graphical user interface, according to some examples.

FIG. 3 illustrates a graphical user interface showing pricing for MLS properties and an “exclusive” visual indicator for non-MLS properties, according to some examples.

FIG. 4 illustrates a map showing pricing interchanged from MLS properties to non-MLS properties, and the “exclusive” visual indicator for non-MLS properties interchanged for property icons, according to some examples.

FIG. 5 illustrates a user interface whereby a selection of a particular non-MLS real estate listing causes additional information to be displayed, according to some examples.

FIG. 6 is a user interface displaying additional information for non-MLS properties, according to some examples.

FIG. 7 illustrates an example user interface displaying a timer indicating when a tour for a non-MLS listing will begin for a real estate listing.

FIG. 8 is a block diagram illustrating a representative software architecture, which may be used in conjunction with various hardware architectures herein described.

FIG. 9 is a block diagram illustrating components of a machine, according to an embodiment, able to read instructions from a machine-readable medium (e.g., a machine-readable storage medium) and perform any one or more of the methodologies discussed herein.

### DETAILED DESCRIPTION

The MLS, or Multiple Listing Service, is a platform used by real estate brokers to share information about properties for sale. Traditional systems face technical challenges in displaying both MLS and non-MLS listings on a graphical user interface due to a rule against commingling these listings.

Traditional real estate systems, such as websites or apps, typically handle this by separating the two types of listings. Some do this by using entirely different websites for MLS and non-MLS listings, ensuring a clear separation. This method, however, forces users who want to search both types of listings to switch back and forth between different websites.

Another approach is to use a toggle switch or other filter to switch between the different types of listings on the same website or platform. This forces users to switch between viewing MLS listings and non-MLS listings and has similar drawbacks as the separate websites explained above.

Other approaches include listing MLS and non-MLS listings in separate sections of the same website, each section marked as MLS or non-MLS listings. For example, there could be a dedicated page or area for MLS listings and a separate one for non-MLS listings. However, this type of display does not allow users to see how certain MLS listings are located in comparison with non-MLS listings. Moreover, displaying the MLS and non-MLS listings in separate sections of the same website causes confusion between the two making it difficult for the user to distinguish between MLS and non-MLS listings.

Example systems described herein address these technical issues by rendering a display of both MLS and non-MLS listings on the same map on a graphical user interface while adhering to the commingling rules, and thus provide an intuitive and visual distinction between the two types of listings. For example, example systems render for display different visual indicators for MLS and non-MLS listings on a same map in a graphical user interface to maintain a clear separation between these listings while allowing display of both types both types of listings on a single, user-friendly platform.

In some examples, example systems differentiate MLS listings from non-MLS listings by using unique visual cues. For instance, key information like the listing's price is prominently displayed on the map for an MLS listing with a distinctively colored pin. Causing display of key information and a distinctly colored pin conveys crucial information and identifies these MLS properties at a glance.

In some examples, non-MLS listings are distinguished from MLS listings through the use of different visual cues. In some examples, instead of showing the price, the visual cues for the non-MLS listings display text labels such as “exclusive” or “non-MLS listing,” or use a unique color to set them apart from MLS listings. These visual cues ensure a clear distinction between the two types of listings to indicate the different nature of these properties.

In response to a user selection of any non-MLS listing, example systems render display of detailed information for the non-MLS listings, such as price, while causing the MLS listings to revert to showing a more basic icon (such as an icon of a house) instead of the price. Causing display of the change in visual indicators provides a seamless transition between viewing MLS and non-MLS listings, while still maintaining a clear demarcation between the two. In this way, example systems provide more information on non-MLS listings while still displaying geographic locations among all non-MLS and MLS listings at the same time.

By integrating both MLS and non-MLS listings into a single map, example systems provide a comprehensive view of all available properties, whether the properties are MLS or non-MLS. This innovative approach adheres to the rule against commingling MLS and non-MLS listings while offering a user-friendly interface that caters to the diverse needs of property seekers, enhancing their property search experience.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in a real estate listing process. Computing resources used by one or more machines, databases, or networks may thus be more efficiently utilized or even reduced.

### Networked System

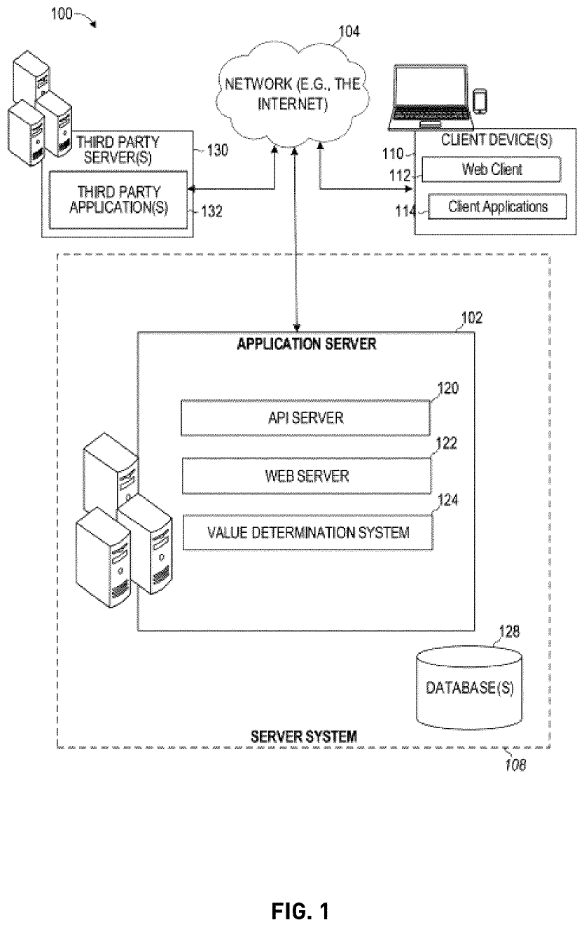

FIG. 1 is a block diagram illustrating a networked system 100, according to some example embodiments, configured to predict a value (closing or sale price) for a real-estate property. The system 100 includes one or more client devices such as client device 110. The client device 110 comprises, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth.

The client device 110 may be a device of a user or operator that is used to access and utilize property buying services (e.g., request a sale price or value to be predicted or estimated for a given real-estate property). For example, the client device 110 may be used to input information to request an automated offer on a subject real-estate property, to request a value of a subject real-estate property, to request one or more real-estate property transaction documents to be automatically selected and populated, to make an offer on a subject real-estate property, to receive and display various information about a subject real-estate property or a market, to view a distribution of values for a subject real-estate property, to view changes to weights and/or comparable adjustments as a function of a distribution of values for a subject real-estate property, and so forth.

In one example, the client device 110 is a device of a given user who would like to sell his or her subject real-estate property. Client device 110 accesses a website of the property buying and selling service (e.g., hosted by server system 108). The user inputs an address of the subject real-estate property and selects an option to receive an automated offer or value of the subject real-estate property in the website. Server system 108 receives the request and identifies comparables or “comps” (e.g., a plurality of comparable real-estate properties) having similar attributes as the subject real-estate property. Server system 108 automatically retrieves characteristics of the subject real-estate property based on the address and searches for comps within a predetermined distance (e.g., 1.2 miles) of the address of the subject real-estate property. In some implementations, the server system 108 applies one or more trained machine learning techniques to identify the comps for the subject real-estate property. The trained machine learning techniques are trained to establish a relationship between attributes of a given real-estate property and attributes of a plurality of comparable real-estate properties. For example, the trained machine learning techniques may be neural networks that identify a set of 10 or more comparable real-estate properties that have recently sold, such as in the past 6 months or 1 year, that are of a similar size, are within a predefined geographical distance, and of the same type as the given or subject real-estate property. Server system 108 then automatically computes or predicts a value for the subject real-estate property and provides the value to the client device 110 instantly or after a period of time (e.g., 24 hours).

In some circumstances, server system 108 involves an operator of a website of the property buying and selling service using an operator device to review the value that was automatically computed before the value is returned to the client device 110. Client device 110 receives the value and provides an option to the user to complete the real-estate property transaction. For example, the user selects an option to complete the sale of the real-estate property. In response, server system 108 automatically generates one or more real-estate property transaction documents (e.g., a contract for sale of the subject real-estate property) and allows the user to execute the documents to complete the sale. After the user executes the documents the subject real-estate property enters a pending status. Server system 108 may present a list of available closing dates to the user. Once the user selects the closing date, the subject real-estate property closes at the contract price on the closing date.

One or more users may be a person, a machine, or other means of interacting with the client device 110. In example embodiments, the user may not be part of the system 100, but may interact with the system 100 via the client device 110 or other means. For instance, the user may provide input (e.g., touch screen input or alphanumeric input) to the client device 110 and the input may be communicated to other entities in the system 100 (e.g., third-party servers 130, server system 108, etc.) via the network 104. In this instance, the other entities in the system 100, in response to receiving the input from the user, may communicate information to the client device 110 via the network 104 to be presented to the user. In this way, the user interacts with the various entities in the system 100 using the client device 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Washington State) or one or more client applications 114. The client device 110 may include one or more client applications 114 (also referred to as “apps”) such as, but not limited to, a web browser, messaging application, electronic mail (email) application, an e-commerce site application, a mapping or location application, an online property buying and selling application, a real estate application, and the like.

In some embodiments, one or more client applications 114 are included in a given one of the client device 110, and configured to locally provide the user interface and at least some of the functionalities, with the client application 114 configured to communicate with other entities in the system 100 (e.g., third-party servers 130, server system 108, etc.), on an as-needed basis, for data and/or processing capabilities not locally available (e.g., to access location information, to access market information related to properties, to authenticate a user, to verify a method of payment, etc.). Conversely, one or more applications 114 may not be included in the client device 110, and then the client device 110 may use its web browser to access the one or more applications hosted on other entities in the system 100 (e.g., third-party servers 130, server system 108, etc.).

A server system 108 provides server-side functionality via the network 104 (e.g., the Internet or wide area network (WAN)) to one or more third-party servers 130 and/or one or more client devices 110. The server system 108 includes an application program interface (API) server 120, a web server 122, a value determination system 124, that may be communicatively coupled with one or more databases 128. The one or more databases 128 may be storage devices that store data related to users of the system 108, applications associated with the system 108, cloud services, housing market data, one or more machine learning techniques and so forth. The one or more databases 128 may further store information related to third-party servers 130, third-party applications 132, client devices 110, client applications 114, users, and so forth. In one example, the one or more databases 128 may be cloud-based storage.

In one example, the one or more databases 128 may be cloud-based storage. The one or more databases 128 may store real-estate property listing information for closed or previously sold real-estate properties. The server system 108 may be a cloud computing environment, according to some example embodiments. The server system 108, and any servers associated with the server system 108, may be associated with a cloud-based application, in one example embodiment.

The server system 108 includes a value determination system 124. Value determination system 124 includes one or more modules, storage devices and databases. The storage devices in value determination system 124 store various real-estate property listings for previously sold properties and properties currently available for sale. The storage devices also store one or more machine learning techniques for identifying comps for a subject real-estate property. The storage devices also store one or more machine learning techniques for predicting a value for the subject real-estate property based on the identified comps by jointly analyzing weights and price or value adjustments of the comps. The modules in value determination system 124 are configured to train a machine learning technique to predict or estimate the value for a given or subject real-estate property by jointly establishing a relationship between weights assigned to comps and value adjustments of the comps and a value of a real-estate property of interest.

The system 100 further includes one or more third-party servers 130. The one or more third-party servers 130 may include one or more third-party application(s) 132. The one or more third-party application(s) 132, executing on third-party server(s) 130, may interact with the server system 108 via API server 120 via a programmatic interface provided by the API server 120. For example, one or more the third-party applications 132 may request and utilize information from the server system 108 via the API server 120 to support one or more features or functions on a website hosted by the third party or an application hosted by the third party. The third-party website or application 132, for example, may provide software version analysis functionality that is supported by relevant functionality and data in the server system 108.

Third-party servers 130 may include a multiple listing service (MLS) server. This service is publicly accessible to real-estate brokers nationwide. A real-estate broker inputs property information to the MLS server (e.g., price information, property attributes, listing date of a property, date contract to sell the property was executed, closing date of the property, etc.) to list the property for sale and to complete transactions for the property. Other brokers can access the MLS server to search and filter properties available for sale or that have been sold and select a given property to view. The MLS server may allow a real-estate broker to provide an offer to purchase a given property being listed for sale on behalf of a buyer. The MLS server may indicate whether and when a given property listing is pending indicating that an executed purchase and sale agreement between a buyer and seller of the real-estate property has been received. The MLS server may indicate whether and when a sale for a given property has been closed indicating that the legal transfer of title to the property from the seller to the buyer has been recorded in a government database.

The MLS server may include a database of real-estate properties. Characteristics of each property stored in the MLS server may also be provided. Characteristics include a location of the property, a school district, a tax rate, a property owners association rate, interior conditions (e.g., whether the property has been renovated, whether the property has stainless steel appliances, whether the property has a pool, whether the property has granite countertops), whether the property is characterized as new construction, whether the property has previously been occupied, and so forth. The information of the MLS server may be included as part of database 128. Any of the MLS real-estate properties information (listing information) may be used by a trained machine learning model to search for and identify comps for a subject real-estate property. After the comps are identified another different machine learning model is applied to the comps and a subject real-estate property to estimate the value for the subject real-estate property. The MLS real-estate properties information may include real-estate property activities and may be used to train a machine learning technique to jointly establish a relationship between the value adjustments of the comps and the respective weights associated with each of the comps and a value of a subject property.

### Real Estate Listing Map GUI Generation System

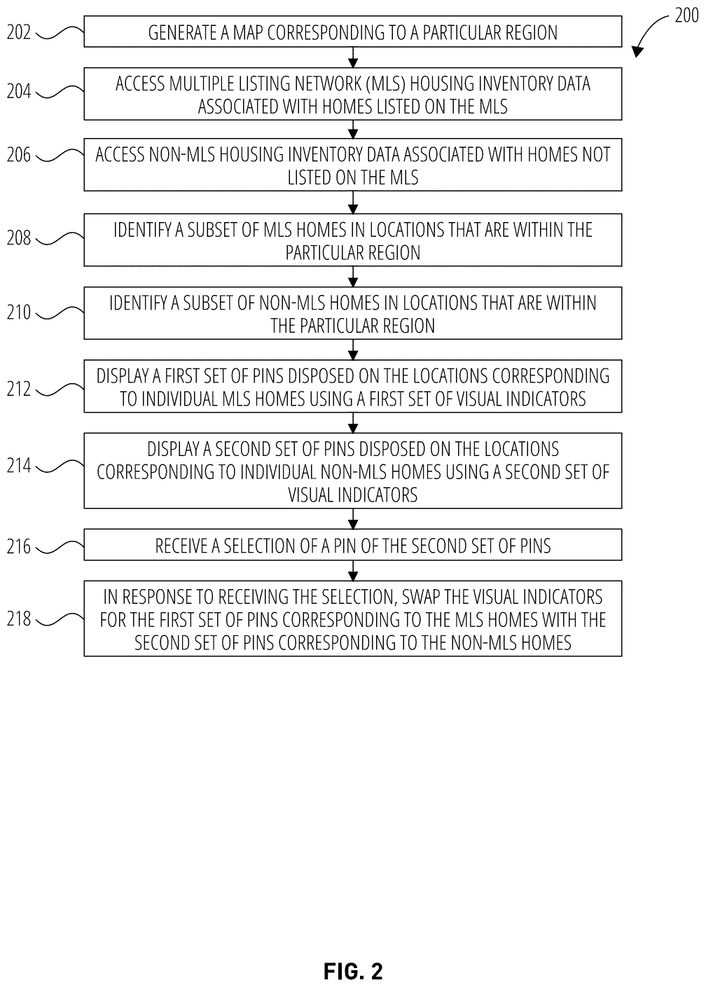

FIG. 2 illustrates an example method 200 for generating and updating real estate visual indicators on a map in a graphical user interface, according to some examples. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

At block 202, a computing system, such as client device 110 or server system 108 (or other system), generates a map corresponding to a particular geographic region. For example, the computing system generates a geographic representation in a graphical user interface on a platform, such as a website or application, comprising an area of interest where MLS and non-MLS listings are located. The generated map allows users to visually navigate the geographic region to view listings in the geographical region.

The area of interest can be specified by a user via the graphical user interface through a variety of input methods, designed to provide flexibility and convenience. For example, a search bar can be provided in the graphical user interface to allow a user to specify a location, via the search bar, including a name of a city, neighborhood, zip code, or even a specific street address. As the user types, the computing system provides suggestions that are displayed to complete the input based on known locations. Once the computing system determines the location entered, the computing system generates a map of a region corresponding to the entered location.

In some cases, the computing system generates an interactive map where users navigate by dragging, zooming in, or zooming out to reach their desired location. In some cases, the computing system uses the GPS or an internet connection to determine the user's current geographical position and generate a map of the surrounding area.

In some cases, users can specify a geographical location using filters, such as proximity to certain landmarks, school districts, or specific geographical features like a lake or mountain range. In some cases, the computing system offers an option to save preferred locations for easy access in the future.

At block 204, the computing system accesses multiple listing network (MLS) housing inventory data associated with properties listed on the MLS. The MLS database includes data from a multiple listing service where real estate agents share comprehensive information about properties they are selling.

The computing system accesses MLS housing inventory data by connecting with the MLS databases which include detailed information about properties listed for sale or rent. For example, the computing system can directly connect with an MLS database via an API (Application Programming Interface). In some cases, the computing system applies a Real Estate Transaction Standard (RETS) protocol used for transferring data between systems. In some cases, the computing system accesses the MLS data via third-party data providers or aggregators that have already established connections with multiple MLS databases. These providers consolidate MLS data from various sources, normalize it into a consistent format, and provide it to platforms via an API.

At block 206, the computing system accesses non-MLS housing inventory data associated with properties not listed on the MLS. The non-MLS data can come from a variety of sources, including private sellers, exclusive agencies, or proprietary databases. In some cases, the computing system allows property owners to directly list their property on the site. Property owners create an account, input property details, upload photos, and provide contact information. In some cases, real estate agents receive property details from property owners and inputs the details into the computing system.

In some cases, the computing system accesses numerous websites where owners can list properties for sale without the use of a real estate agent and thus, without being part of the MLS. The computing system accesses real estate agency and brokerage databases that maintain their own proprietary databases of non-MLS listings, often referred to as “exclusive” or “pocket” listings.

In some cases, the computing system gathers data from public records or government databases, such as county recorder's offices or municipal tax records. The computing system accesses data from third-party data aggregators that collect, normalize, and sell access to non-MLS listings data. The computing system gathers data on foreclosure sales and real estate auctions that also provide non-MLS data. In some cases, the business entity of the computing system owns individual real estate listings and thus has internal data related to the self-owned properties.

In some embodiments, the information received from the various data sources can be of a different format. The computing system can configure data from multiple different databases that are in each in a non-standardized format into a single standardized format. For example, the zipcode of an address can be updated to only include the first 5 digits or address data can be converted into “St.” instead of “Street.” As such, messages can be automatically generated to communicate with third party devices using the standardized format. Moreover, assessments and decisioning made by the computing system can be applied to these third party devices by reapplying non-standardized formatting of the third party. For example, information from the owner of the property can be communicated to third party construction or interior design company databases, or communication from a buyer system can be effectively communicated to the seller system or a lock box (as described further herein).

At block 208, the computing system identifies a subset of MLS properties in locations that are within the particular region. For example, the computing system determines which MLS properties have addresses that are located in the particular region. At block 210, the computing system identifies a subset of non-MLS properties in locations that are within the particular region. For example, the computing system determines which non-MLS properties have addresses that are located in the particular region. The computing system filters both the MLS and non-MLS datasets to select only those properties located within the boundaries of the map. This ensures that only relevant, location-specific listings are displayed to users.

At block 212, the computing system displays a first set of pins disposed on the locations corresponding to individual MLS properties using a first set of visual indicators. At block 214, the computing system displays a second set of pins disposed on the locations corresponding to individual non-MLS properties using a second set of visual indicators.

The visual indicators may differ in color, shape, size, or additional information displayed. For example, MLS pins could be a first color and show the property price, while non-MLS pins could be a second, different color and be labeled as “exclusive” or “non-MLS listing.”

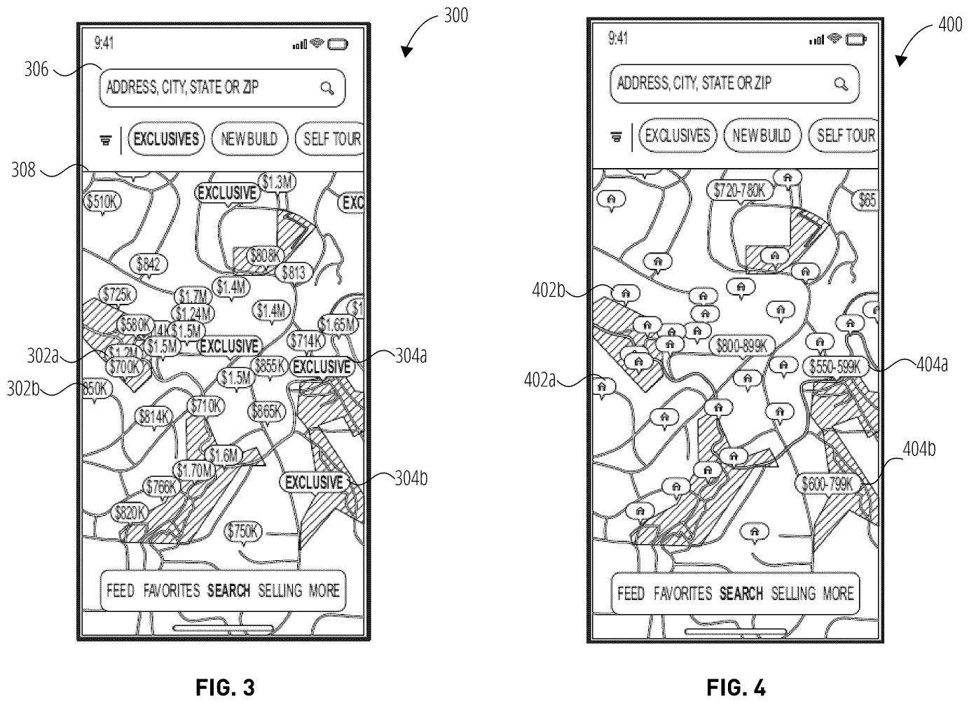

FIG. 3 illustrates a graphical user interface 300 displaying a map 308 showing pricing for MLS properties and an “exclusive” visual indicator for non-MLS properties, according to some examples. The user interface 300 includes a search bar 306 that a user can use to search for a geographical location. The user interface 300 displays a map 308 of the geographical location.

The map 308 includes a subset of MLS property listings, such as listing 302a and 302b (collectively referred to herein as MLS property listings) and a subset of non-MLS property listings are displayed, such as listings 304a and 304b (collectively referred to herein as non-MLS property listings) that have addresses located within the boundaries of the map 308. The subset of MLS property listings show a listing price for the property whereas the subset of non-MLS listings simply show a pin of the location that includes the text “exclusive.” For the sake of simplicity, certain examples are described as property, homes, real estate property. However, it is appreciated that the features described for one type can be applied to others.

Returning to FIG. 2, at block 216, the computing system detects a selection of a pin. For example, the computing system receives a selection of a pin, from the set of pins, which corresponds to a non-MLS listing. This selection is made by a user clicking or tapping on the pin, signaling interest in more detailed information about the property. In some cases, such a selection can occur when a user hovers a mouse over a non-MLS listing pin (e.g., on a desktop interface) or the user holds down a mouse button while hovering over a particular pin (e.g., clicking and holding for a period of time).

In some cases, a user draws a selection box around a group of listings on the map. The selection box can include only listings corresponding to the a set of pins corresponding to non-MLS listings or to a set of pins corresponding to MLS listings. The computing system can also detect a right-click with a mouse (on desktop interfaces) or a long press (on touch interfaces) on a non-MLS listing pin as a selection. In a touch interface, the computing system can detect a pinch to zoom in on a certain area of the map, indicating a selection of a pin or a group of pins.

At block 218, the computing system, in response to detecting the selection, interchanges the visual indicators for the set of pins corresponding to the MLS properties with the set of pins corresponding to the non-MLS properties. For example, the computing system causes display of less information or a different icon for the MLS pins, while displaying more detailed information for the non-MLS pins, such as price. This interchange allows the user to focus on the non-MLS listings while still maintaining a clear distinction between MLS and non-MLS listings on the map. In some cases, the computing system changes the visual indicators for the set of pins corresponding to the MLS properties to the set of pins corresponding to the non-MLS properties, and/or vice versa.

FIG. 4 illustrates a graphical user interface 400 displaying a map showing pricing interchanged from MLS properties to non-MLS properties, and the “exclusive” visual indicator for non-MLS properties interchanged for property icons, according to some examples. The MLS properties 402a and 402b (collectively referred to herein as MLS properties) now are indicated by pins with an icon of a property, whereas the non-MLS properties 404a and 404b (collectively referred to herein as non-MLS properties) are indicated by a listing price. In some cases, an exclusive home may not be officially listed (such as on the MLS). The computing system may list one or more exclusive homes in such cases without a price. In some cases, the computing system estimates a price range (such as based on comparable property values in the area) until the actual price is available.

The selection of a pin from the second set of pins, corresponding to non-MLS listings, triggers a change or interchange of the visual indicators on the map. In some cases, any interaction or a particular interaction with any non-MLS listing pin triggers the interchanging of visual indicators. When the computing system detects a selection or interaction with a non-MLS listing, the computing system activates a function in the computing system's code to interchange the visual indicators. If, for instance, the MLS listings were previously displayed with prices and non-MLS listings were shown with the tag “non-MLS listing,” the computing system interchanges these indicators to cause the MLS listings to display the “MLS listing” tag (or an equivalent icon), and the non-MLS listings to display prices.

This interchanging (e.g., swapping) of visual indicators enhances user interaction and experience by enabling users to easily distinguish between MLS and non-MLS listings. It also helps to comply with MLS rules, which prevent the commingling of MLS and non-MLS listings. Users can still view both types of listings on the same map, but the clear visual distinctions ensure the two are not mixed together, in line with the rules.

The interchanging also contributes to a dynamic user experience. By having the visual indicators change in response to user interactions, users can explore and compare listings in a more engaging way. It encourages users to interact more with the non-MLS listings, as these are now highlighted with a price, which is a critical piece of information for anyone looking for a property.

The computing system can generate a graphical user interface and/or graphical user interface data that optimizes valuable user interface real estate as described above. Such an improved display interface allows a user to more quickly access desired data stored in a mobile application and/or an external database. Moreover, the visual indicators can include a selectable function that can launch a change to the user interface (as further described herein) to provide further information to be seen.

Advantageously, the specific and practical manner of displaying the limited set of information to the user via a map of visual indicators and user interface apportioning improves the technical problem for the user interface in electronic devices over conventional systems by enabling the user to view MLS and non-MLS listings with clear demarcation between the two. Accordingly, the map and the visual indicators that correspond to functions that launch an apportionment of the user interface and provide functionality to switch from MLS to non-MLS pins for more information improve the speed of the user's navigation through various views and windows. The user is saved from navigating to different websites or selecting various filters to identify data of interest and/or creating a manual map to compare the MLS and non-MLS listings side by side. Moreover, the user is saved from paging through multiple screens of different MLS and non-MLS listing maps, where the map of the computing system described herein can enable the user to access the relevant data in response to a single view and a few clicks of the user.

The computing system reverts the visual indicators back to their original state (such as from FIG. 4 to FIG. 3) when a user interacts with a pin from the set that corresponds to MLS listings. When a user selects an MLS listing (after the interchanging of visual indicators has occurred), the computing system detects this interaction and triggers reverting the visual indicators back to the original state. For instance, if the MLS listings were displaying as a property icon and non-MLS listings were showing prices after the first interchange, the computing system would now revert these indicators. The MLS listings would display their prices again, and the non-MLS listings would go back to displaying “exclusive” or a different icon. Because the price for both MLS and non-MLS houses are not shown at the same time, the pin without the price is not an official listing, and thus does not violate the MLS commingling rule.

Just as with the original interchange, the selection or interaction that causes the visual indicators to revert back could take various forms, such as a click, tap, hover, voice command, keyboard shortcut, or any other user interaction that the computing system recognizes as a selection of a pin.

This ability to continuously interchange and then revert the visual indicators helps to create a dynamic and interactive user experience. It allows users to explore and compare both MLS and non-MLS listings in an engaging way. The interchanging of visual indicators highlights the selected type of listing and distinguishes it from the other, enhancing user understanding and navigation. Then, the ability to revert back to the original state ensures that users can easily switch between focusing on MLS and non-MLS listings.

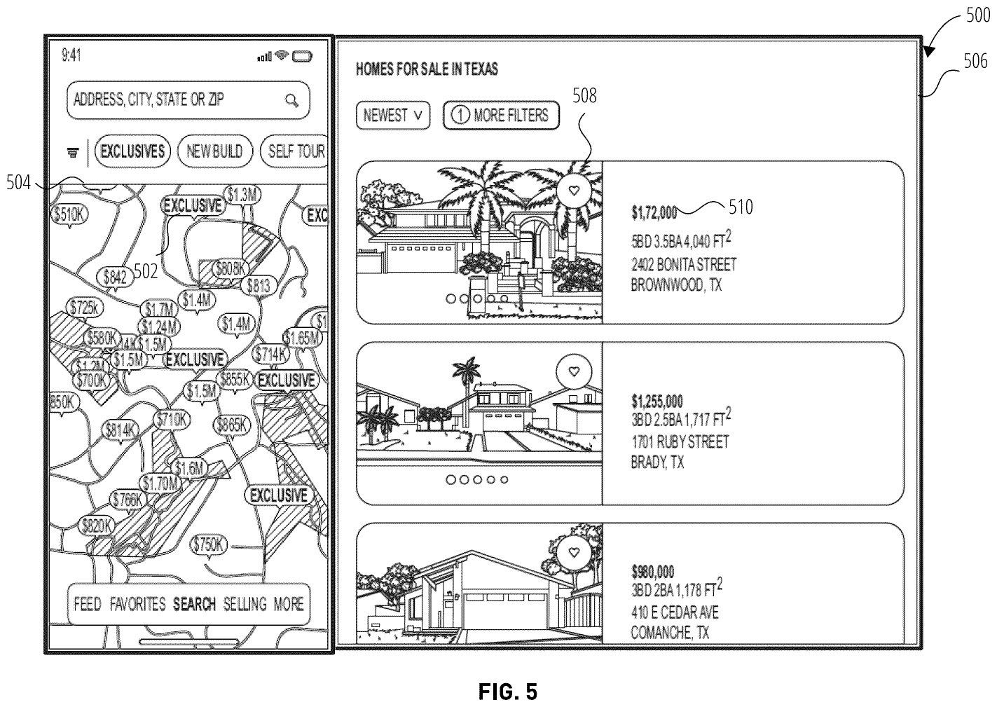

In some examples, the computing system generates additional information and provides additional features. FIG. 5 illustrates a user interface 500 whereby a selection of a particular non-MLS real estate listing causes additional information to be displayed, according to some examples. In response to detecting a user selection of an individual pin 502 of either a set of pins corresponding to MLS listings or a set of pins corresponding to non-MLS listings, the computing system reduces the size of the map 504 on the user interface and displays additional information of a listing corresponding to the selected individual pin in the newly available user interface space 506. The additional information can include pictures 508 of the property, pricing 510, and other information useful for a buyer of a real estate property.

In some cases, the selection for additional information is based on detecting a single click, a click when the icon is showing certain information (such as the price or a color), press and hold of the pin, clicking twice, and/or the like.

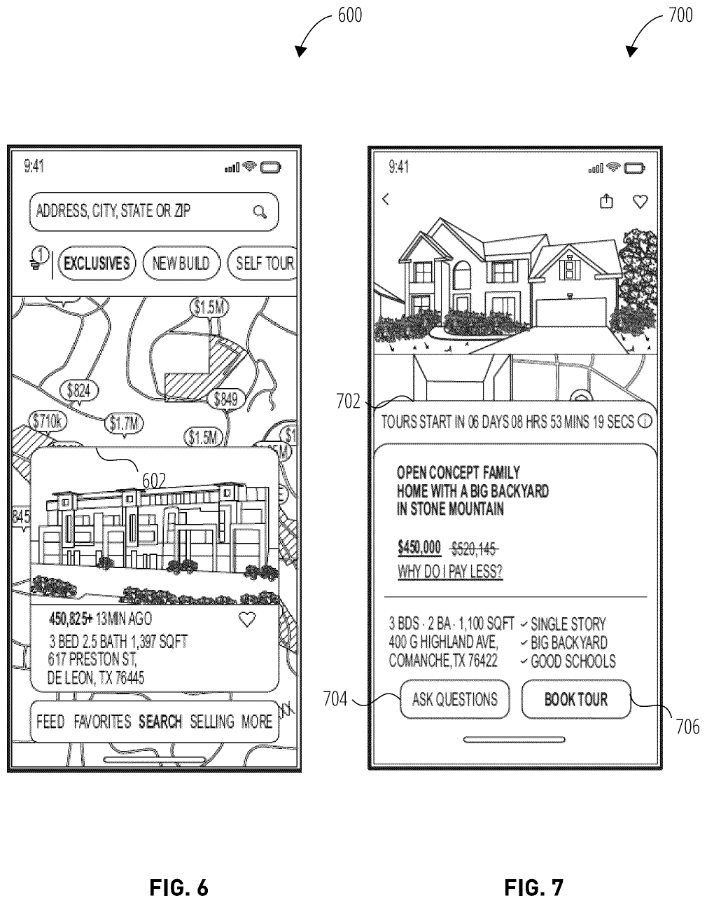

In some cases, the type of additional information displayed for non-MLS properties is different than the type of additional information displayed for MLS properties. Moreover, in some examples the listing format is different between MLS and non-MLS properties. For example, FIG. 5 can be a display for providing additional information related to MLS properties. FIG. 6 is a user interface 600 displaying additional information for non-MLS properties, according to some examples. As shown, FIG. 6 displays additional information 602 for non-MLS properties in a different format and template than MLS properties in FIG. 5.

The additional information for the non-MLS properties takes a different portion of the user interface than the MLS properties. For example, the additional information in FIG. 6 is an overlay on top of the map. Similar technical advantages as described herein apply, such as where valuable real estate is optimized and reducing the amount of selections the user has to make to see and identify relevant information. Although examples describe MLS properties showing a particular format or non-MLS properties showing a particular format, it is appreciated that the formats can be applied to MLS or non-MLS properties.

In some examples, the additional information displayed for individual non-MLS properties include a timer indicative of how long the individual non-MLS property remains on the map. In some cases, in response to a lapse of the timer, the computing system converts the individual non-MLS property to an MLS property. A non-MLS listing becomes an MLS (Multiple Listing Service) listing through a series of steps. The computing system automatically collects all relevant information about the property, such as the location, square footage, number of rooms, notable features, recent upgrades or renovations, and/or the like. The computing system generates a listing for the property and submits the listing to the MLS. The MLS then verifies the information and publishes the listing.

Once the listing is published on the MLS, the real estate property is officially an MLS listing. It can now be seen and accessed by other real estate professionals who use the MLS, and also syndicates to various consumer-facing real estate websites. As such, the home transitions from having characteristics of a non-MLS home to an MLS home, as described further herein.

FIG. 7 illustrates an example user interface 700 displaying a timer 702 indicating when a tour for a non-MLS listing will begin for a real estate listing. In some examples, this timer information for a tour is not available from the MLS database.

In some cases, the non-MLS listing includes other information that may not be available for a typical MLS listing from the MLS database. Although an MLS listing may include certain renovations or repairs that have been made, it does not include detailed information about the work done, such as the quality of the materials used, the specific changes made, or the contractor who did the work. The computing system includes such information, which can be important for understanding the true value and condition of the property.

The MLS may provide some basic information about a property's structure and systems, such as the age of the roof or the type of heating system, but it usually does not provide comprehensive details. In some examples, the computing system displays such information for non-MLS homes, such as information about the condition of the plumbing or electrical systems, the insulation in the attic, or potential foundation issues.

The MLS provides the location of the property, but it does not typically provide in-depth details about the neighborhood. The computing system can generate such information from publicly available sources, such as the U.S. Census Bureau, city data, government websites, school database, and/or the like, and display the information in the user interface. This information can include the quality of nearby schools, crime rates, local amenities, or neighborhood culture.

There is other information that is not included in the MLS. For example, information about future development plans in the area, which could affect the future value of the property, is typically not included in MLS listings. Details about environmental risks like flooding, wildfires, or radon exposure are not included in the MLS. Although the listing price and potential mortgage estimates are usually included, detailed financial history like past sale prices, property tax history, or property owners' association fees may not be fully detailed in the MLS. The MLS typically does not include the seller's reason for selling the property, which could potentially be useful information for a buyer. Information about the type of insurance required, potential challenges in securing insurance, or average insurance costs for the property are usually not included in the MLS. The computing system can provide this type of information in a format (such as FIG. 6) that is different than the MLS format (e.g., FIG. 5). For example, the computing system can generate this information from publicly available sources and display the information in the user interface.

In some cases, the computing system provides services and/or offerings not typically included in an MLS listing. For example, the computing system provides an appraisal price match guarantee for users making property purchases on the computing system for non-MLS listings. In some cases, the computing system provides users with floorplans, a video walkthrough of the property, renderings of a virtual 3D space of the property (such as an AI-generated space for a 360 degree walkthrough or tour), information from previous owners, inspection reports, and/or the like.

In some examples, the computing system accesses additional information directly from an owner of a property. In some cases, an entity associated with the computing system owns the property and thus already has such information stored locally. In some cases, the computing system communicates with third party databases storing such data to access the additional information, such as current renovation status data from an interior design company database, current construction status from a construction company database, an inspection report from an inspector database, and/or the like.

As described herein, the computing system retrieves information from multiple databases in different formats. The computing system adapts the information to its own standardized format to enable comparison, data checking across multiple data sources, consistent data display to the user, and data sharing with other systems. In some cases, the computing system retrieves information from third party databases or users, such as an indication when the home is open for users to tour, when a home has photographs added, when the price has been added or modified, when the home is listed on the MLS, and/or the like.

In some cases, alerts are set up to provide updates to potential buyers based on their preferences or the status of certain properties. The computing system establishes these alerts based on updates from various sources, including construction companies, interior designers, repair, budgeting companies, and others, giving the potential buyer a broader picture of a property's value and potential. The computing system can send the alerts to third parties to update on seller and/or buyer progress, and/or to the sellers as well.

In some cases, the user can ask a question directly of the owner of the property by selecting a user interface element 704. Upon detecting selection of the user interface element, the computing system establishes a direct messaging chat between the user and the owner. In some cases, the computing system initiates a phone call or email thread directly with the owner. In some cases, the user can ask a question regarding the property before a tour is available. Once touring of the property is available, the computing system replaces the user interface element that initiates asking a question with a user interface that facilitates booking a tour of the property. In some cases, the user can ask a question directly to a team member of the computing system, such as an operations team member, by selecting a user interface element 704 using the features described herein.

In some cases, the computing system enables users to book a tour, such as a self-guided tour, to see the property. The computing system provides an in-app scheduling feature which obviates the need to communicate directly with the owner of the property. In some examples, the computing system displays a user selectable interface element that enables the user to receive alerts when a tour is available of the property.

One requirement for an automated self-guided tour is a way for potential buyers to securely access the property. In one example, the computing system provides secure access to the property by communicating with a smart lock located at the property. When a user schedules a tour through the app, the computing system provides a one-time access code that unlocks the door (such as during the scheduled tour time). In some cases, the computing system automatically unlocks the key box via a wireless communication channel from the computing system to the key box (such as when the potential purchaser or seller selects a feature on the application).

In some cases, the user can select a user interface element on the user's mobile phone to unlock the key box in real-time, and the computing system can communicate the unlock command directly with the key box. In response to a user selection of the user selectable interface element, the computing system causes unlocking of a key box for the individual non-MLS property via a wireless communication channel. In some cases, a label (such as a barcode or QR code) on the app or on the keybox can be read to unlock the key box, a door, or other feature to enable access to the property.

In some examples, the computing system communicates directly with a user profile (such as credit scores, income, amount in accounts, and/or the like) and can communicate with financial institutions to facilitate loan pre-approval. The computing system can then display a user's maximum purchase amount. The computing system can facilitate communications between the user, user profile, and financial institution's servers to generate a loan contract and/or proceed to underwrite a loan for the buyer.

In some examples, the computing system submits a bid directly on the property details page. The buyers and/or sellers enter their offer amount, proposed closing date, contingencies, and other pertinent details. Sellers and buyers have an option to respond directly within the app, either accepting, rejecting, or countering the offer. If the seller counters, the potential buyer would receive a notification and can respond accordingly.

Once an offer is accepted, the computing system initiates the next steps in the process, which can involve automatically scheduling an inspection (with a service provider integrated into the app) and finalizing the loan details. In some examples, the computing system proposes recommended third parties, such as inspection systems. In some examples, the computing system automatically communicates with inspection systems to initiate inspections in response to a user selection or automatic selection of the inspection system.

The computing system communicates with the financial institution to finalize the loan, coordinate with a closing service to arrange the details of the property transfer, and update both buyer and seller about the status of the transaction until it is complete.

After the purchase, the computing system provides recommendations and/or automatically selects resources for moving, property improvement, and setting up property services, potentially offering opportunities for further integrations with third-party providers. Upon selection by the user or automatic selection, the computing system sends third parties communication of the request for services and initiates proceeding with these services.

In some cases, the computing system requires potential buyers to go through an identity verification process before they're allowed to schedule a tour. This could involve checking their ID, credit history, or other personal information.

In some cases, the user interface element 706 enables a user to take virtual tours of the property. These tours give viewers a full 360-degree view of each room or space in a property. In some cases, 3D tours use special cameras to capture depth information in addition to color. This allows for a more realistic, immersive view of the space, and can even be viewed in virtual reality (VR) for a full 3D effect.

In some examples, the computing system includes displaying a feed of listings, such as listings displayed in rows. The user can select a toggle switch as a filter, and the computing system filters either MLS or non-MLS listings based on the toggle switch selection either on the feed of listings and/or on the map of a certain region.

### Software Architecture

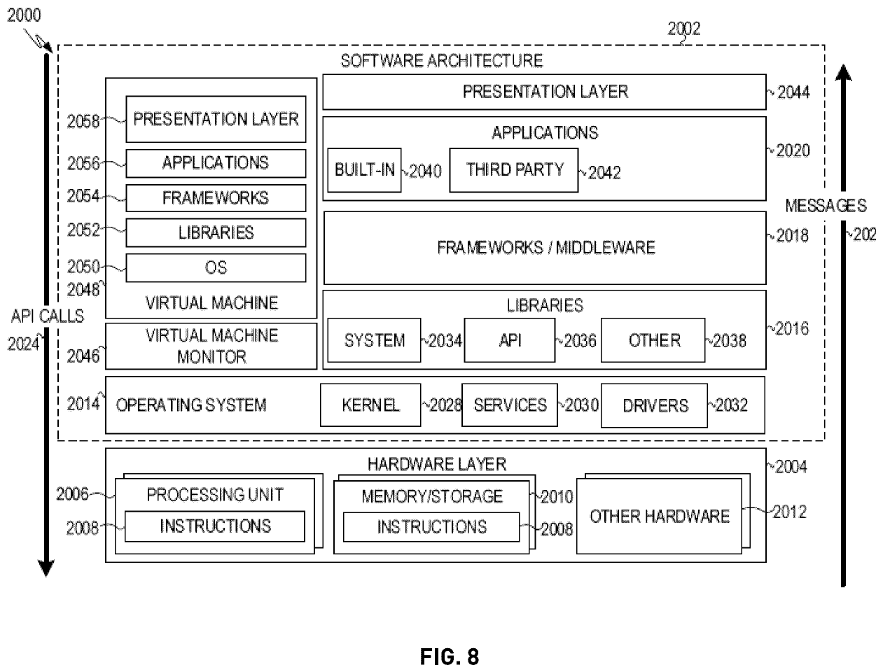

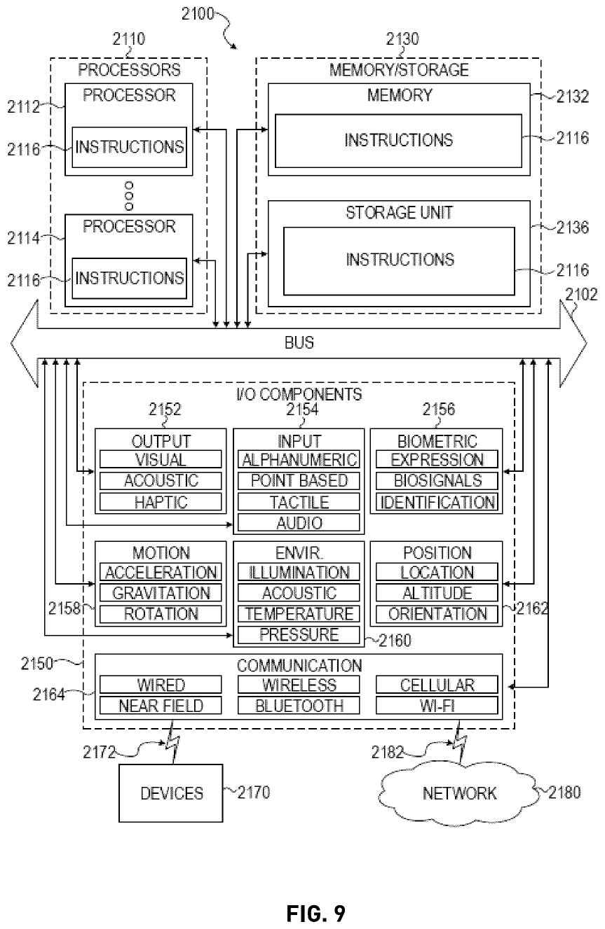

FIG. 8 is a block diagram 2000 illustrating a representative software architecture 2002, which may be used in conjunction with various hardware architectures herein described. FIG. 8 is merely a non-limiting example of a software architecture 2002, and it will be appreciated that many other architectures may be implemented to facilitate the functionality described herein. The software architecture 2002 may be executing on hardware such as a machine 2100 of FIG. 9 that includes, among other things, processors 2110, memory/storage 2130, and input/output (I/O) components 2150. Returning to FIG. 8, a representative hardware layer 2004 is illustrated and can represent, for example, the machine 2100 of FIG. 9. The representative hardware layer 2004 comprises one or more processing units 2006 having associated executable instructions 2008. The executable instructions 2008 represent the executable instructions of the software architecture 2002, including implementation of the methods, engines, modules, and so forth of FIGS. 1C-3B. The hardware layer 2004 also includes memory and/or storage modules 2010, which also have the executable instructions 2008. The hardware layer 2004 may also comprise other hardware 2012, which represents any other hardware of the hardware layer 2004, such as the other hardware 2012 illustrated as part of the machine 2100.

In the example architecture of FIG. 8, the software architecture 2002 may be conceptualized as a stack of layers where each layer provides particular functionality. For example, the software architecture 2002 may include layers such as an operating system 2014, libraries 2016, frameworks/middleware 2018, applications 2020, and a presentation layer 2044. Operationally, the applications 2020 and/or other components within the layers may invoke API calls 2024 through the software stack and receive a response, returned values, and so forth, illustrated as messages 2026, in response to the API calls 2024. The layers illustrated are representative in nature, and not all software architectures have all layers. For example, some mobile or special purpose operating systems 2014 may not provide a frameworks/middleware 2018 layer, while others may provide such a layer. Other software architectures may include additional or different layers.

The operating system 2014 may manage hardware resources and provide common services. The operating system 2014 may include, for example, a kernel 2028, services 2030, and drivers 2032. The kernel 2028 may act as an abstraction layer between the hardware and the other software layers. For example, the kernel 2028 may be responsible for memory management, processor management (e.g., scheduling), component management, networking, security settings, and so on. The services 2030 may provide other common services for the other software layers. The drivers 2032 may be responsible for controlling or interfacing with the underlying hardware. For instance, the drivers 2032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be utilized by the applications 2020 and/or other components and/or layers. The libraries 2016 typically provide functionality that allows other software modules to perform tasks in an easier fashion than to interface directly with the underlying operating system 2014 functionality (e.g., kernel 2028, services 2030, and/or drivers 2032). The libraries 2016 may include system libraries 2034 (e.g., C standard library) that may provide functions such as memory allocation functions, string manipulation functions, mathematic functions, and the like. In addition, the libraries 2016 may include API libraries 2036 such as media libraries (e.g., libraries to support presentation and manipulation of various media formats such as moving picture experts group (MPEG) 4, H.264, MPEG-1 or MPEG-2 Audio Layer (MP3), augmentative and alternative communication (AAMC), adaptive multi-rate audio codec (AMR), joint photography experts group (JPG), or portable network graphics (PNG)), graphics libraries (e.g., an Open Graphics Library (OpenGL) framework that may be used to render two dimensional (2D) and three dimensional (3D) graphic content on a display), database libraries (e.g., Structured Query Language (SQL), SQLite that may provide various relational database functions), web libraries (e.g., WebKit that may provide web browsing functionality), and the like. The libraries 2016 may also include a wide variety of other libraries 2038 to provide many other APIs to the applications 2020 and other software components/modules.

The frameworks (also sometimes referred to as middleware) may provide a higher-level common infrastructure that may be utilized by the applications 2020 and/or other software components/modules. For example, the frameworks/middleware 2018 may provide various graphical user interface (GUI) functions, high-level resource management, high-level location services, and so forth. The frameworks/middleware 2018 may provide a broad spectrum of other APIs that may be utilized by the applications 2020 and/or other software components/modules, some of which may be specific to a particular operating system 2014 or platform.

The applications 2020 include built-in applications 2040 and/or third party applications 2042. Examples of representative built-in applications 2040 may include, but are not limited to, a contacts application, a browser application, a book reader application, a location application, a media application, a messaging application, and/or a game application. Third party applications 2042 may include any of the built-in applications as well as a broad assortment of other applications 2020. In a specific example, the third party application 2042 (e.g., an application developed using the Android™ or iOS™ software development kit (SDK) by an entity other than the vendor of the particular platform) may be mobile software running on a mobile operating system 2014 such as iOS™, Android™, Windows® Phone, or other mobile operating systems 2014. In this example, the third party application 2042 may invoke the API calls 2024 provided by the mobile operating system such as the operating system 2014 to facilitate functionality described herein.

The applications 2020 may utilize built-in operating system functions (e.g., kernel 2028, services 2030, and/or drivers 2032), libraries (e.g., system libraries 2034, API libraries 2036, and other libraries 2038), and frameworks/middleware 2018 to create user interfaces to interact with users of the system. Alternatively, or additionally, in some systems, interactions with a user may occur through a presentation layer, such as the presentation layer 2044. In these systems, the application/module “logic” can be separated from the aspects of the application/module that interact with a user.

Some software architectures 2002 utilize virtual machines. In the example of FIG. 8, this is illustrated by a virtual machine 2048. The virtual machine 2048 creates a software environment where applications/modules can execute as if they were executing on a hardware machine (such as the machine 2100 of FIG. 9, for example). The virtual machine 2048 is hosted by a host operating system (e.g., operating system 2014 in FIG. 8) and typically, although not always, has a virtual machine monitor 2046, which manages the operation of the virtual machine 2048 as well as the interface with the host operating system (e.g., operating system 2014). A software architecture executes within the virtual machine 2048, such as an operating system 2050, libraries 2052, frameworks/middleware 2054, applications 2056, and/or a presentation layer 2058. These layers of software architecture executing within the virtual machine 2048 can be the same as corresponding layers previously described or may be different.

### Example Machine Architecture and Machine-Readable Medium

FIG. 9 is a block diagram illustrating components of a machine 2100, according to an embodiment, able to read instructions from a machine-readable medium (e.g., a machine-readable storage medium) and perform any one or more of the methodologies discussed herein. Specifically, FIG. 9 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. For example, the instructions 2116 may include a set of instructions that cause the machine 2100 to execute the flow diagrams described herein. Additionally, or alternatively, the instructions 2116 may implement the modules described herein. The instructions 2116 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines 2100. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 2100 capable of executing the instructions 2116, sequentially or otherwise, that specify actions to be taken by the machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory/storage 2130, and I/O components 2150, which may be configured to communicate with each other such as via a bus 2102. In an example embodiment, the processors 2110 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 2112 and a processor 2114 that may execute the instructions 2116. The term “processor” is intended to include multi-core processors 2110 that may comprise two or more independent processors 2110 (sometimes referred to as “cores”) that may execute the instructions 2116 contemporaneously. Although FIG. 9 shows multiple processors 2110, the machine 2100 may include a single processor 2110 with a single core, a single processor 2110 with multiple cores (e.g., a multi-core processor), multiple processors 2110 with a single core, multiple processors 2110 with multiples cores, or any combination thereof.

The memory/storage 2130 may include a memory 2132, such as a main memory, or other memory storage, and a storage unit 2136, both accessible to the processors 2110 such as via the bus 2102. The storage unit 2136 and memory 2132 store the instructions 2116, embodying any one or more of the methodologies or functions described herein. The instructions 2116 may also reside, completely or partially, within the memory 2132, within the storage unit 2136, within at least one of the processors 2110 (e.g., within the processor's cache memory), or any suitable combination thereof, during execution thereof by the machine 2100. Accordingly, the memory 2132, the storage unit 2136, and the memory of the processors 2110 are examples of machine-readable media.

As used herein, “machine-readable medium” means a device able to store the instructions 2116 and data temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 2116. The term “machine-readable medium” shall also be taken to include any medium, or combination of multiple media, that is capable of storing instructions (e.g., instructions 2116) for execution by a machine (e.g., machine 2100), such that the instructions, when executed by one or more processors of the machine (e.g., processors 2110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2150 may include a wide variety of components to receive input, provide output, produce output, transmit information, exchange information, capture measurements, and so on. The specific I/O components 2150 that are included in a particular machine 2100 will depend on the type of machine. For example, portable machines 2100 such as mobile phones will likely include a touch input device or other such input mechanisms, while a headless server machine will likely not include such a touch input device. It will be appreciated that the I/O components 2150 may include many other components that are not shown in FIG. 9. The I/O components 2150 are grouped according to functionality merely for simplifying the following discussion and the grouping is in no way limiting. In various example embodiments, the I/O components 2150 may include output components 2152 and input components 2154. The output components 2152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 2150 may include biometric components 2156, motion components 2158, environmental components 2160, or position components 2162 among a wide array of other components. For example, the biometric components 2156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2158 may include acceleration sensor components (e.g., accelerometer), gravitation sensor components, rotation sensor components (e.g., gyroscope), and so forth. The environmental components 2160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 2162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 2180 or devices 2170 via a coupling 2182 and a coupling 2172, respectively. For example, the communication components 2164 may include a network interface component or other suitable device to interface with the network 2180. In further examples, the communication components 2164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 2170 may be another machine 2100 or any of a wide variety of peripheral devices (e.g., a peripheral device coupled via a USB).

Moreover, the communication components 2164 may detect identifiers or include components operable to detect identifiers. For example, the communication components 2164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2164, such as location via IP geolocation, location via Wi-Fi® signal triangulation, location via detecting an NFC beacon signal that may indicate a particular location, and so forth.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: generating a map corresponding to a particular region; accessing Multiple Listing Network (MLS) real estate inventory data associated with MLS real estate listings included in an MLS database; accessing non-MLS real estate inventory data associated with non-MLS real estate properties not included in the MLS database; identifying a subset of MLS real estate listings located within the particular region; identifying a subset of non-MLS real estate properties located within the particular region; displaying, on a user interface, the generated map comprising a first set of visual indicators, each visual indicator of the first set of visual indicators displayed at a location corresponding to an MLS real estate listing; displaying, on the user interface, a second set of visual indicators on the generated map, each visual indicator of the second set of visual indicators displayed at a location corresponding to a non-MLS real estate property; detecting a selection of a visual indicator in the first set of visual indicators; and in response to detecting the selection: changing the first set of visual indicators for the MLS real estate listings to the second set of visual indicators; and changing the second set of visual indicators for the non-MLS real estate listings to the first set of visual indicators.

In Example 2, the subject matter of Example 1 includes, wherein before the changing of the first and second set of visual indicators, the operations further comprise: detecting a selection of a visual indicator of the first set of visual indicators; and in response to detecting the selection of the visual indicator of the first set of visual indicator, changing back the visual indicators for the first set of visual indicators corresponding to the MLS real estate listings with the second set of visual indicators corresponding to the non-MLS real estate properties.

In Example 3, the subject matter of Examples 1-2 includes, wherein the operations further comprise, before the changing of the first and second set of visual indicators, displaying prices for each of the MLS real estate listings on the map corresponding to individual locations and not displaying prices for the non-MLS real estate properties.

In Example 4, the subject matter of Example 3 includes, wherein displaying the second set of visual indicators comprises displaying text or an icon indicating that the real estate properties are non-MLS real estate properties.

In Example 5, the subject matter of Examples 3-4 includes, wherein the operations further comprise, in response to receiving the selection, displaying prices for each of the non-MLS real estate properties on the map in locations corresponding to the individual non-MLS real estate properties and not displaying prices for the MLS real estate listings.

In Example 6, the subject matter of Examples 4-5 includes, wherein the operations further comprise: receiving a selection of a visual indicator of the first set of visual indicators; and in response to receiving the selection of the visual indicators of the first set of visual indicators, displaying prices for each of the MLS real estate listings on the map in locations corresponding to the individual MLS real estate listings and not displaying prices for the non-MLS real estate property.

In Example 7, the subject matter of Examples 1-6 includes, wherein the operations further comprise, in response to receiving a selection of any visual indicator of the second set of visual indicators, changing back the visual indicators for the first set of visual indicators corresponding to the MLS real estate listings with the second set of visual indicators corresponding to the non-MLS real estate properties.

In Example 8, the subject matter of Example 7 includes, wherein the operations further comprise, in response to receiving the selection of any visual indicator of the first set of visual indicators, changing back the visual indicators for the first set of visual indicators corresponding to the MLS real estate listings with the second set of visual indicators corresponding to the non-MLS real estate properties.

In Example 9, the subject matter of Examples 1-8 includes, wherein the operations further comprise, in response to a user selection of an individual visual indicator of either the first or second set of visual indicators, reduce a size of the map on the user interface and display additional information of the real estate property corresponding to the selected individual visual indicator in the newly available user interface space.

In Example 10, the subject matter of Example 9 includes, wherein a type of information for the additional information displayed for non-MLS real estate properties when a non-MLS real estate property is selected is different than a type of information for the additional information displayed for MLS real estate listings when an MLS real estate listing is selected.

In Example 11, the subject matter of Examples 9-10 includes, wherein the additional information displayed for individual non-MLS real estate listings include a user selectable interface element that initiates a self-guided tour, wherein the operations further comprise, in response to a user selection of the user selectable interface element, causing unlocking of a key box for the individual non-MLS real estate property via a wireless communication channel.

In Example 12, the subject matter of Examples 9-11 includes, wherein the additional information displayed for individual non-MLS real estate properties include a user selectable interface element that initiates a self-guided tour, wherein the operations further comprise, in response to a user selection of the user selectable interface element, automatically facilitating and completing the self-guided tour without contacting an owner of the individual non-MLS real estate properties.

In Example 13, the subject matter of Examples 9-12 includes, wherein the additional information displayed for individual non-MLS real estate properties include a timer indicative of how long the individual non-MLS real estate property remains on the map as a non-MLS real estate property.

In Example 14, the subject matter of Examples 10-13 includes, wherein the operations further comprise, in response to a lapse of the timer, converting the individual non-MLS real estate property to an MLS real estate listing.

In Example 15, the subject matter of Examples 9-14 includes, wherein the operations further comprise, for individual non-MLS real estate properties, retrieve updates from one or more third party databases storing data regarding current renovation status, current construction status, and/or an inspection report.

In Example 16, the subject matter of Example 15 includes, wherein the operations further comprise enabling one or more alerts when one or more updates are received from the third party databases.

In Example 17, the subject matter of Examples 9-16 includes, wherein the operations further comprise, displaying, for individual non-MLS real estate properties, a timer indicative of when a tour of the non-MLS real estate properties will become available.

In Example 18, the subject matter of Examples 1-17 includes, wherein detecting the selection of the visual indicator comprises detecting a cursor hovering over the visual indicator.

Example 19 is a method comprising: generating a map corresponding to a particular region; accessing Multiple Listing Network (MLS) real estate inventory data associated with MLS real estate listings included in an MLS database; accessing non-MLS real estate inventory data associated with non-MLS real estate properties not included in the MLS database; identifying a subset of MLS real estate listings located within the particular region; identifying a subset of non-MLS real estate properties located within the particular region; displaying, on a user interface, the generated map comprising a first set of visual indicators, each visual indicator of the first set of visual indicators displayed at a location corresponding to an MLS real estate listing; displaying, on the user interface, a second set of visual indicators on the generated map, each visual indicator of the second set of visual indicators displayed at a location corresponding to a non-MLS real estate property; detecting a selection of a visual indicator in the first set of visual indicators; and in response to detecting the selection: changing the first set of visual indicators for the MLS real estate listings to the second set of visual indicators; and changing the second set of visual indicators for the non-MLS real estate listings to the first set of visual indicators.

Example 20 is a non-transitory computer-readable storage medium storing instructions that, when executed by at least one processor, cause the at least one processor to perform operations comprising: generating a map corresponding to a particular region; accessing Multiple Listing Network (MLS) real estate inventory data associated with MLS real estate listings included in an MLS database; accessing non-MLS real estate inventory data associated with non-MLS real estate properties not included in the MLS database; identifying a subset of MLS real estate listings located within the particular region; identifying a subset of non-MLS real estate properties located within the particular region; displaying, on a user interface, the generated map comprising a first set of visual indicators, each visual indicator of the first set of visual indicators displayed at a location corresponding to an MLS real estate listing; displaying, on the user interface, a second set of visual indicators on the generated map, each visual indicator of the second set of visual indicators displayed at a location corresponding to a non-MLS real estate property; detecting a selection of a visual indicator in the first set of visual indicators; and in response to detecting the selection: changing the first set of visual indicators for the MLS real estate listings to the second set of visual indicators; and changing the second set of visual indicators for the non-MLS real estate listings to the first set of visual indicators.

Example 21 is at least one machine-readable medium including instructions that, when executed by processing circuitry, cause the processing circuitry to perform operations to implement of Examples 1-20.

Example 22 is an apparatus comprising means to implement of Examples 1-20.

Example 23 is a system to implement of Examples 1-20.

Example 24 is a method to implement of Examples 1-20.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
generating a map corresponding to a particular region;
accessing Multiple Listing Network (MLS) real estate inventory data associated with MLS real estate listings included in an MLS database;
accessing non-MLS real estate inventory data associated with non-MLS real estate properties not included in the MLS database;
identifying a subset of MLS real estate listings located within the particular region;
identifying a subset of non-MLS real estate properties located within the particular region;
displaying, on a user interface, the generated map comprising a first set of visual indicators, each visual indicator of the first set of visual indicators displayed at a location corresponding to an MLS real estate listing;
displaying, on the user interface, a second set of visual indicators on the generated map, each visual indicator of the second set of visual indicators displayed at a location corresponding to a non-MLS real estate property;
detecting a selection of a visual indicator in the first set of visual indicators; and
in response to detecting the selection:
changing the first set of visual indicators for the MLS real estate listings to the second set of visual indicators; and
changing the second set of visual indicators for the non-MLS real estate listings to the first set of visual indicators.

2. The system of claim 1, wherein before the changing of the first and second set of visual indicators, the operations further comprise:
detecting a selection of a visual indicator of the first set of visual indicators; and
in response to detecting the selection of the visual indicator of the first set of visual indicator, changing back the visual indicators for the first set of visual indicators corresponding to the MLS real estate listings with the second set of visual indicators corresponding to the non-MLS real estate properties.

3. The system of claim 1, wherein the operations further comprise, before the changing of the first and second set of visual indicators, displaying prices for each of the MLS real estate listings on the map corresponding to individual locations and not displaying prices for the non-MLS real estate properties.

4. The system of claim 3, wherein displaying the second set of visual indicators comprises displaying text or an icon indicating that the real estate properties are non-MLS real estate properties.

5. The system of claim 3, wherein the operations further comprise, in response to receiving the selection, displaying prices for each of the non-MLS real estate properties on the map in locations corresponding to the individual non-MLS real estate properties and not displaying prices for the MLS real estate listings.

6. The system of claim 4, wherein the operations further comprise:
receiving a selection of a visual indicator of the first set of visual indicators; and
in response to receiving the selection of the visual indicators of the first set of visual indicators, displaying prices for each of the MLS real estate listings on the map in locations corresponding to the individual MLS real estate listings and not displaying prices for the non-MLS real estate property.

7. The system of claim 1, wherein the operations further comprise, in response to receiving a selection of any visual indicator of the second set of visual indicators, changing back the visual indicators for the first set of visual indicators corresponding to the MLS real estate listings with the second set of visual indicators corresponding to the non-MLS real estate properties.

8. The system of claim 7, wherein the operations further comprise, in response to receiving the selection of any visual indicator of the first set of visual indicators, changing back the visual indicators for the first set of visual indicators corresponding to the MLS real estate listings with the second set of visual indicators corresponding to the non-MLS real estate properties.

9. The system of claim 1, wherein the operations further comprise, in response to a user selection of an individual visual indicator of either the first or second set of visual indicators, reduce a size of the map on the user interface and display additional information of the real estate property corresponding to the selected individual visual indicator in the newly available user interface space.

10. The system of claim 9, wherein a type of information for the additional information displayed for non-MLS real estate properties when a non-MLS real estate property is selected is different than a type of information for the additional information displayed for MLS real estate listings when an MLS real estate listing is selected.

11. The system of claim 9, wherein the additional information displayed for individual non-MLS real estate listings include a user selectable interface element that initiates a self-guided tour, wherein the operations further comprise, in response to a user selection of the user selectable interface element, causing unlocking of a key box for the individual non-MLS real estate property via a wireless communication channel.

12. The system of claim 9, wherein the additional information displayed for individual non-MLS real estate properties include a user selectable interface element that initiates a self-guided tour, wherein the operations further comprise, in response to a user selection of the user selectable interface element, automatically facilitating and completing the self-guided tour without contacting an owner of the individual non-MLS real estate properties.

13. The system of claim 9, wherein the additional information displayed for individual non-MLS real estate properties include a timer indicative of how long the individual non-MLS real estate property remains on the map as a non-MLS real estate property.

14. The system of claim 10, wherein the operations further comprise, in response to a lapse of the timer, converting the individual non-MLS real estate property to an MLS real estate listing.

15. The system of claim 9, wherein the operations further comprise, for individual non-MLS real estate properties, retrieve updates from one or more third party databases storing data regarding current renovation status, current construction status, and/or an inspection report.

16. The system of claim 15, wherein the operations further comprise enabling one or more alerts when one or more updates are received from the third party databases.

17. The system of claim 9, wherein the operations further comprise, displaying, for individual non-MLS real estate properties, a timer indicative of when a tour of the non-MLS real estate properties will become available.

18. The system of claim 1, wherein detecting the selection of the visual indicator comprises detecting a cursor hovering over the visual indicator.

19. A method comprising:
generating a map corresponding to a particular region;
accessing Multiple Listing Network (MLS) real estate inventory data associated with MLS real estate listings included in an MLS database;
accessing non-MLS real estate inventory data associated with non-MLS real estate properties not included in the MLS database;
identifying a subset of MLS real estate listings located within the particular region;
identifying a subset of non-MLS real estate properties located within the particular region;
displaying, on a user interface, the generated map comprising a first set of visual indicators, each visual indicator of the first set of visual indicators displayed at a location corresponding to an MLS real estate listing;
displaying, on the user interface, a second set of visual indicators on the generated map, each visual indicator of the second set of visual indicators displayed at a location corresponding to a non-MLS real estate property;
detecting a selection of a visual indicator in the first set of visual indicators; and
in response to detecting the selection:
changing the first set of visual indicators for the MLS real estate listings to the second set of visual indicators; and
changing the second set of visual indicators for the non-MLS real estate listings to the first set of visual indicators.

20. A non-transitory computer-readable storage medium storing instructions that, when executed by at least one processor, cause the at least one processor to perform operations comprising:
generating a map corresponding to a particular region;
accessing Multiple Listing Network (MLS) real estate inventory data associated with MLS real estate listings included in an MLS database;
accessing non-MLS real estate inventory data associated with non-MLS real estate properties not included in the MLS database;
identifying a subset of MLS real estate listings located within the particular region;
identifying a subset of non-MLS real estate properties located within the particular region;
displaying, on a user interface, the generated map comprising a first set of visual indicators, each visual indicator of the first set of visual indicators displayed at a location corresponding to an MLS real estate listing;
displaying, on the user interface, a second set of visual indicators on the generated map, each visual indicator of the second set of visual indicators displayed at a location corresponding to a non-MLS real estate property;
detecting a selection of a visual indicator in the first set of visual indicators; and
in response to detecting the selection:
changing the first set of visual indicators for the MLS real estate listings to the second set of visual indicators; and
changing the second set of visual indicators for the non-MLS real estate listings to the first set of visual indicators.
